(19) United States
(12) Patent Application Publication
(10) Pub. No.: US 2021/0220211 A1
(43) Pub. Date: Jul. 22, 2021

(54) Animal Self-Massage Device

(71) Applicant: Neal E. Weisman, Philadelphia, PA (US)

(72) Inventor: Neal E. Weisman, Philadelphia, PA (US)

(21) Appl. No.: 16/749,040

(22) Filed: Jan. 22, 2020

(51) Int. Cl. A61H 7/00; A01K 29/00

(52) U.S. Cl. CPC A61H 7/002; A01K 29/00; A61H 2203/03; A61H 2201/1652; A61H 2201/1692; A61H 2201/12

(57) ABSTRACT

An animal self-massage device includes a massage base having massage elements for contacting the body of an animal and means for releasably attaching the massage base to an animal.

### BACKGROUND OF THE INVENTION

### 1. Field of the Invention

The present invention relates to accessories for pets

### 2. Brief Description of the Prior Art

Massage devices for pets are known. Typically, such devices incorporate a mechanism for producing vibrations and an arrangement for transmitting the vibrations to the exterior coat of a pet animal. For example, U.S. Pat. No. 6,675,743 discloses a massage blanket for pets including a plurality of vibration devices and a battery pouch for powering the vibration devices. U.S. Pat. No. 6,142,963 discloses a vibrating blanket with adjustable vibration frequency and intensity. U.S. Patent Publication 2008/0110414 discloses a pet blanket with a temperature controlling fabric. British Patent GB 2444031 discloses a massaging device for a horse incorporating electrically operated vibrators. German Patent Publication DE 10200003 discloses an electrically driven massage blanket for horses. Animal behavior has been studied from pre-historic times. A common behavior of dogs and other animals is to roll on their backs. This behavior may be prompted by an attempt to scratch an itch, as a sign of submissiveness, to pick up the scent of another animal, to get attention, to regulate body temperature, or for other reasons. Prior art animal massage devices either require humans to administer the massage manually or with the aid of electrically powered vibration devices. Further, such prior art devices do not provide adequate massage in the stomach and back general area of an animal. Examples of such devices are animal gloves, brushes, jackets, and vibrating blankets. Further, in general an animal is not able to provide any positive or negative feedback to the human administering the massage. There is a continuing need for an animal massage device that will enhance the well-being of pet animals, their owners, and other animals.

### SUMMARY OF THE INVENTION

The present invention provides an animal self-massage device comprising a massage base comprising a sheet material. The sheet material includes a plurality of massage elements for contacting the body of an animal. The device also includes means for releasably attaching the massage base to the body of an animal. Preferably, the massage base is formed from a semi-flexible material. Preferably, the massage elements extend outwardly from a generally flat surface for contacting the body of the animal at a plurality of contact points. Preferably, the massage elements are distributed evenly over the surface of the massage base. Preferably, in one presently preferred embodiment the massage elements are cylindrically symmetric. Preferably, the massage elements have a generally bell-shaped cross-section. Preferably, in one presently preferred embodiment, the massage base has a pair of sides and massage elements extend from one side. Preferably, the massage elements are distributed evenly over the massage base. Preferably, in one presently preferred embodiment, the massage elements have a generally bell-shaped cross-section. Preferably, the means for releasably attaching the massage base comprises a plurality of straps. Preferably, in one presently preferred embodiment, the massage base is adapted to extend over the back of an animal. Preferably, in a presently preferred embodiment, the massage base is adapted to extend over the sides of an animal. Preferably, in a presently preferred embodiment the massage base is adapted to extend over the belly of an animal. Preferably, in another presently preferred embodiment the massage base is adapted to extend over only one side of an animal.

### BRIEF DESCRIPTION OF THE DRAWINGS

FIG. 1 is a schematic side elevational view of an animal self-massage device according to the present invention shown being worn by a dog.

FIG. 2 is a schematic side elevational view of the animal self-massage device of FIG. 1 shown being worn by a dog rubbing its belly against the ground and obtaining a self-massage.

FIG. 3 is a schematic side elevational view of the animal self-massage device of FIG. 1 shown being worn by a dog rubbing its back against the ground to obtain a self-massage.

FIG. 4 is a top plan view of the animal self-massage device of FIG. 1 shown before attaching the device to a dog.

FIG. 4a is a fragmentary, enlarged top plan view of the self-massage device of FIG. 4.

FIG. 4b is a fragmentary side elevational view of the self-massage device of FIG. 4.

### DETAILED DESCRIPTION

The present invention provides an animal self-massage device. The device preferably includes a semi-flexible blanket or massage base with massage elements such as protrusions for contacting an animal's body to massage the animal's body, such as an animal's stomach and/or back, through contact with the ground. Wearing the animal self-massage device permits the animal to massage the animal's stomach or back area using the animal's own applied force and contact with the ground. Means are also provided to releasably attach the massage device to an animal, such as straps to fasten the device around an animal's back. The means are preferably adapted to prevent the blanket from sliding when the animal rolls on the ground. The animal self-massage device of the present invention can be employed with either domesticated or non-domesticated animals to provide care and comfort. Non-domesticated animals may include animals kept in a stable or zoo. The animal self-massaging device of the present invention can be used for providing a massage, for example, to the stomach, sides and/or back general area of an animal. Animals may benefit from massages for a variety of reasons such as the ease of anxiety, sore muscles, cramps, or digestive purposes.

The attachment means, such as straps, allows the animal self-massage device of the present invention to be used on small, medium, and large domestic and non-domestic animals. In addition, the animal self-massage device permits an animal freedom of movement, such as being able to easily walk around, with the device still attached.

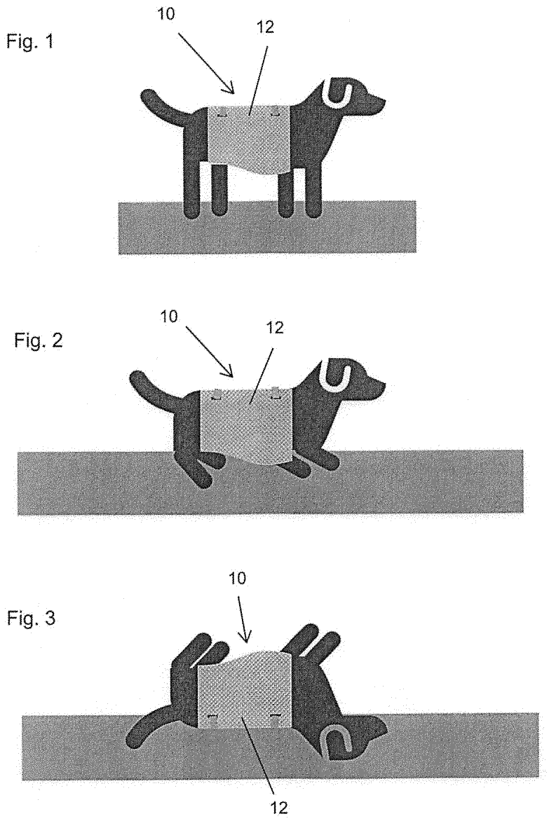

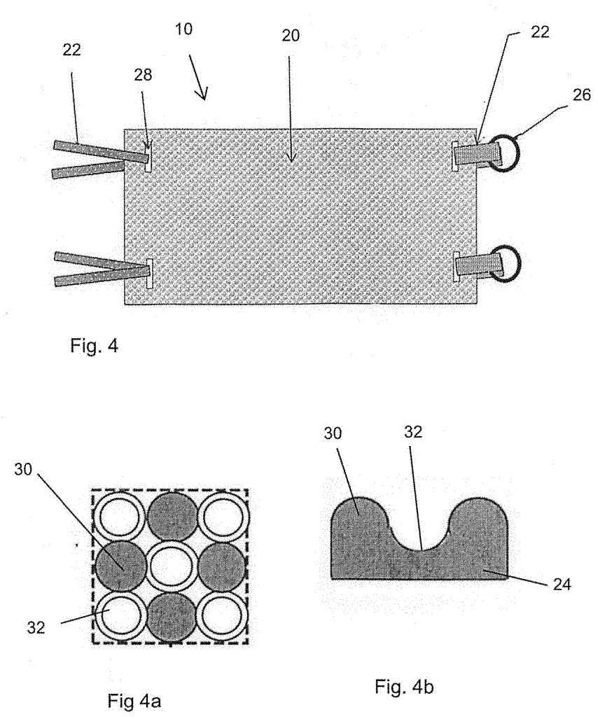

FIG. 1 is a schematic side elevational view of an animal self-massage device 10 of the present invention wrapped around the stomach, sides and back of an exemplary animal, namely a medium sized dog. The device 10 is shown wrapped around the dog's midsection and secured by two pairs of straps 22. FIG. 2 is a schematic side elevational view of the animal self-massage device 10 of the present invention shown while the animal self-administers a massage by rolling on its stomach. FIG. 3 is a schematic side elevational view of the animal self-massage device of the present invention shown while the animal self-administers a massage by rolling on its back. FIG. 4 is a top plan view of the animal self-massage device 10 of the present invention shown lain flat before securing the device 10 to an animal. The device 10 includes a massage base 20 comprising a sheet material 24 from which extend a plurality of massage elements 30 best seen in the fragmentary elevational view of FIG. 4b. The massage elements 30 and sheet material 24 can be integrally formed from a semi-flexible or elastomeric material such as a natural rubber, high density polyethylene, a thermoplastic elastomer, polyvinyl chloride, or combinations thereof. Preferably, the massage base 20 is tough enough to resist tearing by the animal, flexible enough to conform closely to the body of the animal around which it is being secured, yet hard enough to provide an invigorating massage experience for the animal wearing the device 10. The massage elements 30 can be cylindrically symmetric, and have a generally bell-shaped (or half-spherical) cross-section, such as shown in FIGS. 4a and 4b. However, other geometries for the massage elements 30 can also be adopted. The massage elements 30 can take the form of half-sphere protrusions with half-sphere “pits” 32 extending between the protrusions. The massage elements 30 are preferably distributed uniformly over one side of the sheet material 24, although other distributions of the massage elements 30 may also be appropriate, depending on the anatomy of the animal being provided with an animal self-massage device 10 of the present invention. Similarly, while the massage base 20 illustrated in the drawing has a generally rectangular conformation, other geometries can be adopted, preferably guided by the anatomy of the targeted animal. The massage elements 30 are preferably arranged centered in squares such as shown in FIG. 4b, or centered in diamonds (not shown), to provide a high density of massage elements 30 on the sheet material 24. In one presently preferred embodiment, the massage elements 30 are arranged so that they measure about one-half inch center to center. Preferably, the sheet material 24 is about one-half inch thick (as measured from the bottom of the sheet material 24 to the bottom of the “pits” 32), and may optionally be reinforced such as with fibrous material to add strength. Preferably, the overall thickness of the massage base 20 is about one and one-half inches. The height and spacing of the massage elements 30 can be adapted as required to provide the desired massage action to specific species and/or breeds of animals. For example, dogs with heavy or wiry coats may require massage elements 30 that protrude further from the sheet material 24 and/or be formed from a flexible material with a higher modulus to increase stiffness. Similarly, enhanced massage action may be provided by employing more pointed or sharper massage elements 30, such as massage elements 30 having a diamond-like cross-section (not shown).

As can be seen in FIG. 4, the flexible blanket or massage base 20 has elevated protrusions or massage elements 30 with depressed pits or “protrusions” 32 extending therebetween. The means for attaching the massage base 20 includes two pairs of flexible straps 22 to one side of the massage base 20, a pair of rings 26 to attach the straps 22, and a pair of apertures, such as rectangular perforations 28, in the flexible massage base 20, through which the straps 22 can be threaded to cinch the straps 22 and hence the massage base 20 to an animal.

Various modifications can be made in the details of the various embodiments of the articles of the present invention, all within the scope and spirit of the invention as defined by the appended claims.

1. An animal self-massage device comprising:
a massage base comprising a sheet material, the sheet material including a plurality of massage elements for contacting the body of an animal, and
means for releasably attaching the massage base to the body of an animal.

2. An animal self-massage device according to claim 1 wherein the massage base is formed from a semi-flexible material.

3. An animal self-massage device according to claim 1 wherein the massage elements extend outwardly from a generally flat surface for contacting the body of the animal at a plurality of contact points.

4. An animal self-massage device according to claim 3 wherein the massage elements are distributed evenly over the surface of the massage base.

5. An animal self-massage device according to claim 3 wherein the massage elements are cylindrically symmetric.

6. An animal self-massage device according to claim 5 wherein the massage elements have a generally bell-shaped cross-section.

7. An animal self-massage device according to claim 1 wherein the massage base has a pair of sides and massage elements extend from one side.

8. An animal self-massage device according to claim 7 wherein the massage elements are distributed evenly over the massage base.

9. An animal self-massage device according to claim 8 wherein the massage elements are cylindrically symmetric.

10. An animal self-massage device according to claim 9 wherein the massage elements have a generally bell-shaped cross-section.

11. An animal self-massage device according to claim 1 wherein the means for releasably attaching the massage base comprises a plurality of straps.

12. An animal self-massage device according to claim 1 wherein the massage base is adapted to extend over the back of an animal.

13. An animal self-massage device according to claim 1 wherein the massage base is adapted to extend over the sides of an animal.

14. An animal self-massage device according to claim 1 wherein the massage base is adapted to extend over the belly of an animal.

15. An animal self-massage device according to claim 1 wherein the massage base is adapted to extend over one side of an animal.
